(19) United States
(12) Patent Application Publication
(10) Pub. No.: US 2003/0188264 A1
(43) Pub. Date: Oct. 2, 2003

(54) Method and apparatus for XML data normalization

(75) Inventors: Sandeep Nawathe, Sunnyvale, CA (US); Vaishali Angal, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Full Degree, Inc., Palo Alto, CA

(21) Appl. No.: 10/112,147

(22) Filed: Mar. 29, 2002

(51) Int. Cl. G06F 15/00

(52) U.S. Cl. 715/513

(57) ABSTRACT

A method and apparatus for XML data normalization have been described.

### FIELD OF THE INVENTION

The present invention pertains to common information in a data structure. More particularly, the present invention relates to a method and apparatus for XML data normalization.

### BACKGROUND OF THE INVENTION

Many companies are adopting the use of XML (extensible Markup Language) for a variety of applications, such as, structured documents, data on the web, data in databases, etc. XML is a well formed language and is a tree structure style of database. In XML there may be a duplication of information where the same information may be needed in several places. This is due to the nature of XML where a child node in a tree may only have a single parent node. This duplication of information may consume more data storage, slow updates of the same information, etc.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment in which the method and apparatus of the present invention may be implemented;

FIG. 2 is a block diagram of a computer system;

FIG. 3 illustrates one example of an XML tree structure;

FIG. 4 illustrates one example of a graph structure with data normalization;

FIG. 5 illustrates one example of a structure having a set of nodes;

FIG. 6 illustrates one embodiment of the tree structure in FIG. 5 represented as a linked list structure;

FIG. 7 illustrates one example of the duplication of data;

FIG. 8 illustrates one example of a soft link;

FIG. 9 illustrates one example of a structure with edges and nodes;

FIG. 10 illustrates one example of a structure with edges, nodes, and a soft link;

FIG. 11 illustrates one example of a structure with edges, nodes, and multiple soft links;

FIG. 12 illustrates one example of de-normalizing the structure in FIG. 11 and representing it as a tree structure;

FIG. 13 illustrates one example of adding node data to a node that previously had a soft link;

FIG. 14 illustrates an array of objects;

FIG. 15 illustrates one embodiment of a logical data model using linked lists;

FIG. 16 illustrates one embodiment of a logical data model using arrays of objects; and

FIG. 17 illustrates one embodiment of a logical data model using chunks.

### DETAILED DESCRIPTION

A method and apparatus for XML data normalization are described.

The present invention by providing for soft links, allows for normalization of data. The soft links are implemented to allow for easy mapping to, and from, a well-formed XML data structure. Thus, the advantages of XML and the advantages of data normalization may be obtained.

Normalization, normal, normal form, etc. are terms of art. Some of these terms have very different meanings. Within the context of XML there is “normalization” with respect to attributes with values that may change based on external information sources and/or are predefined. We shall refer to this as references to external entities for determining a final value, external value normalization, etc. An example of this in XML, is where all line breaks must be normalized to the sequence #xA (line feed). Thus, a carriage-return (#xD) and line feed (#xA) sequence (#xD#xA) must be “normalized” to #xA (line feed). The present invention is generally not related to this “normalization” and so references to it will be explicitly noted.

The present invention is more related to “data normalization” with respect to database design. In database design, database normalization is often described in “forms.” For example, a first normal form (denoted 1 NF) is generally defined as having no multivalued attributes and no repeating groups. 2NF generally requires that any non-key field be dependent upon the entire key. 3NF generally is defined as prohibiting any attribute in a table being dependent on any non-key attribute in the table. There are also higher and other forms and these are known by those skilled in the art. Normalization as used in the database design context relates to organizing data such that the results are unambiguous. Another goal of efficient normalization is the reduction in duplication of data with the resultant reduction in data storage requirements. This “normalization” where there is a reduction in redundancy is what the present invention deals with. As such, by default unless stated otherwise, the word “normalization” refers to reduction in redundancy in a database structure.

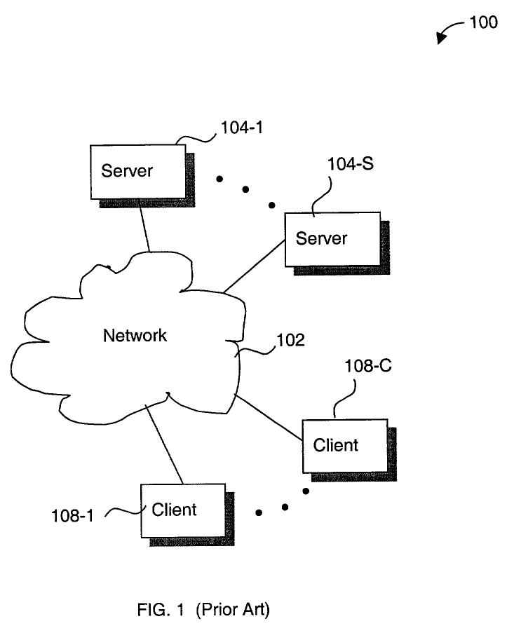

FIG. 1 illustrates a network environment 100 in which the techniques described may be applied. The network environment 100 has a network 102 that connects S servers 104-1 through 104-S, and C clients 108-1 through 108-C. More details are described below.

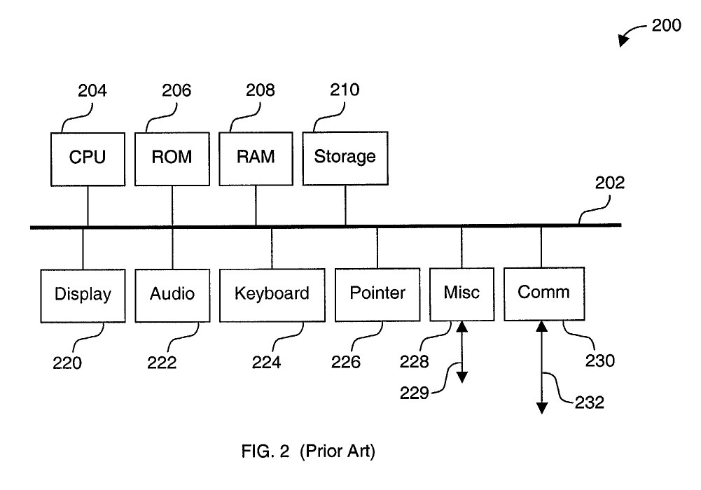

FIG. 2 illustrates a computer system 200 in block diagram form, which may be representative of any of the clients and/or servers shown in FIG. 1. More details are described below.

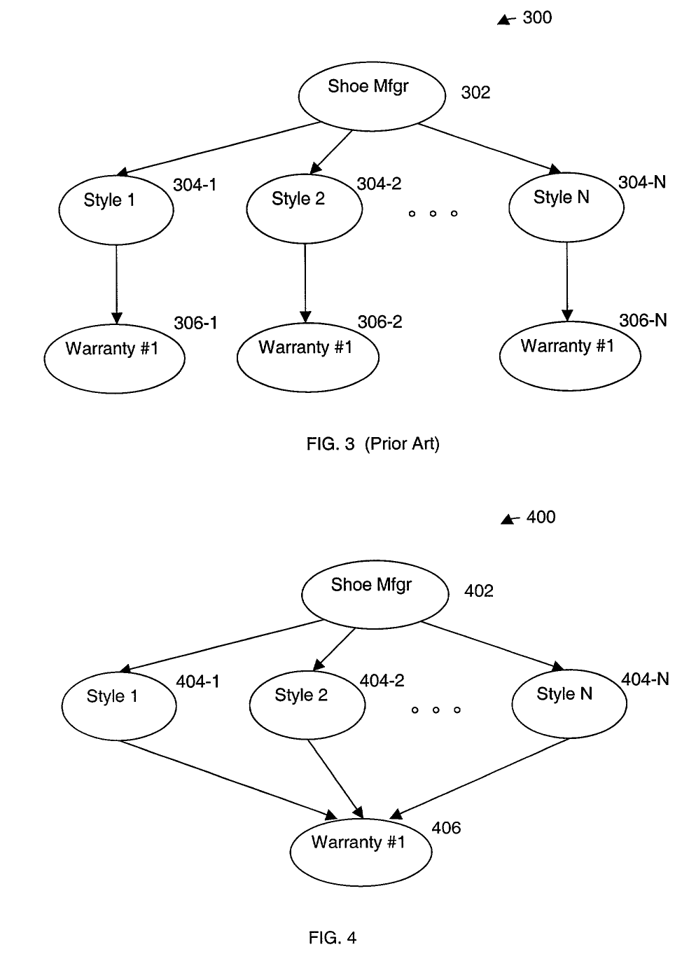

FIG. 3 illustrates one example of an XML tree structure 300. Here a shoe manufacturer 302 has N styles of shoes (302-1 through 302-N) each which has the same Warranty #1 (304-1 through 304-N). This is an example without data normalization. Note that Warranty #1 data must be stored with each style of shoe. Thus, the Warranty #1 data is repeated N times.

FIG. 4 illustrates a graph structure 400 with data normalization. Here a shoe manufacturer 402 has N styles of shoes (402-1 through 402-N) each which has the same Warranty #1 (404). Note that Warranty #1 data need be stored only once, and that each style of shoe (402-1 through 402-N) references Warranty #1.

The advantages in storage and ease in updating Warranty #1 in FIG. 4 are evident over the storage requirements and multiple updates needed in FIG. 3. What is to be further appreciated is that a graph may be converted to a tree, and a tree may be mapped to a table. Furthermore, as detailed in U.S. patent application No. Ser. No. 10/058,266 filed on Jan. 25, 2002, hereby incorporated herein by reference, is a method and apparatus for database mapping of XML objects into a relational database. Thus, a graph may be mapped to a fixed set of tables. The fixed set of tables may also be a fixed set of different sized tables. What is to be understood is that a fixed size for a particular table refers to the columns in the particular table and not the rows. The columns may be considered the types of data that may be stored, while the rows are considered different instances of such data. Thus, whereas a RDB may use tables with rows of columns of values and links, XML may use, for example, a document with tags (elements and possibly attributes), values, and a tree hierarchy.

Referring back to FIG. 3 it will be noticed that each Warranty #1 (306-1 through 306-N) only has a single parent (Style 1 through Style N respectively). Referring back to FIG. 4 it will be noticed that Warranty #1 (406) has multiple parents (Style 1 through Style N). The multiple parent for a node allows for sharing of information and normalization.

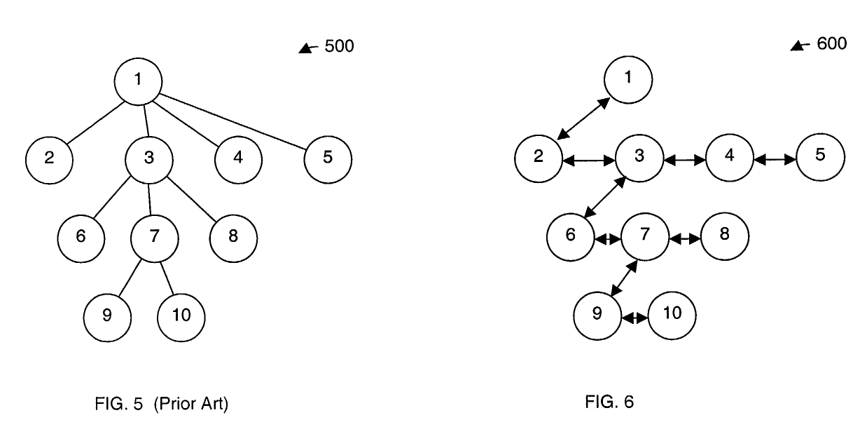

The extension of a representation of XML to handle normalized data may best be illustrated by considering an example in which an XML sibling relationship is split out for the sake of normalization. Thus, one may consider this as representing XML as a structure versus data. As has been shown in U.S. patent application No. Ser. No. 10/058,266 filed on Jan. 25, 2002, a representation in XML may be represented by, for example, linked lists, arrays of objects, chunks, etc. Referring to FIG. 5 is a tree structure 500 having a set of nodes (1 through 10). FIG. 6 illustrates how the tree in FIG. 5 may be represented as a linked list structure. In FIG. 600, for example, node 7 is the parent to node 9 and 10 as represented by a linked list.

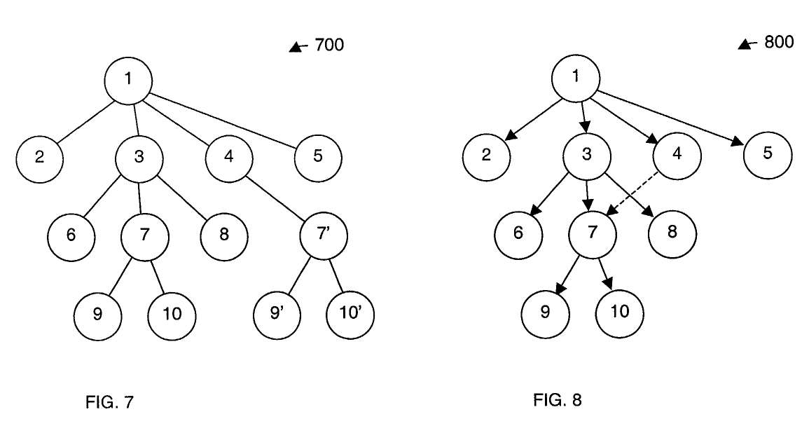

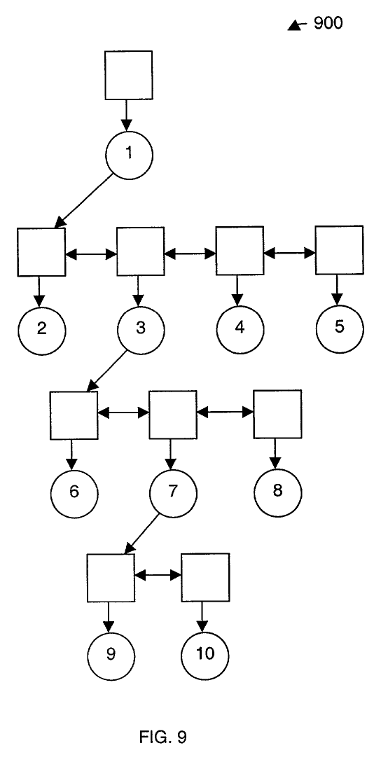

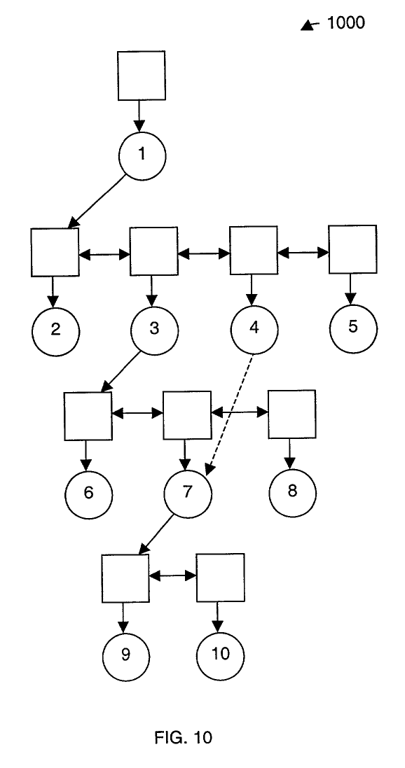

Now, if node 4 in FIG. 5 were modified to include the data in nodes 7, 9, and 10, then FIG. 7 structure 700 would result, where 7′, 9′, and 10′ are duplicates of data at nodes 7, 9, and 10 respectively. Normalization of data in FIG. 7 would require that node 4 indicate that child 7′ is the same as node 7. In the linked list representation, as shown in FIG. 6, this is not possible because a link from node 4 to node 7 would include not only nodes 7, 9, and 10, but also 6 and 8. What is needed is a soft link as illustrated in FIG. 8 where the structure 800 has the soft link denoted by the dashed line from node 4 to 7. This soft link would then represent the sharing of node 7 (and nodes below) information allowing for data normalization. In this scheme then, a node may have more than one parent. Note additionally, that in FIG. 8 arrows now indicate a direction, thus, while FIG. 7 illustrates a tree structure, FIG. 8 illustrates a directed graph.

To represent the structure 800 having a soft link is possible in several ways. For illustration purposes, we will first discuss its representation in a liked list format. As previously mentioned a linked list format may represent an XML structure in a set of fixed size tables in a relational database. Thus, representation of the structure 800 in FIG. 8 as a linked list would provide for XML data normalization.

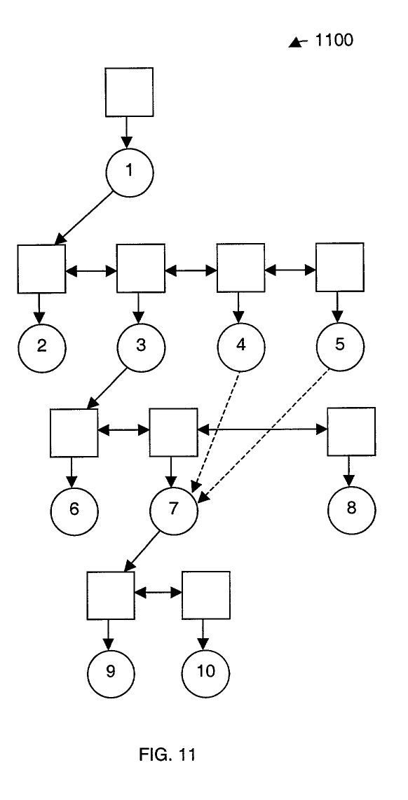

One embodiment for representation, is to separate the sibling relationship for the sake of normalization. FIG. 9 illustrates a structure 900 in which the square blocks (□) represent edges and the circles (◯) represent nodes. The representation in FIG. 9 is similar to that of FIG. 6, however, in FIG. 6, the node data and node to node relationship were not differentiated. Now in FIG. 9, the nodes and edges are represented separately. That is, we now have information relating to node data and node connectivity.

As explained before, in FIG. 6 a link from node 4 to 7 would result in unwanted nodes 6, and 8 being included in the relationship. However, when the connectivity and data are separated at the sibling levels, such a link may be established in a linked list structure. For example, in FIG. 10 is a structure 1000 in which a soft link is shown (via the dashed line) from node 4 to node 7. In this representation format, node 4 now has node 7, 9, and 10 data and not node 6 and/or node 8 data.

As illustrated in FIG. 10 in the structure 1000, an edge (□) only has one downlink to a node (◯). The edge (□) may have 0, 1, or 2 sibling links to other edges (□). A node (◯) may have 0 or 1 links to another node (◯) or an edge (□).

If as illustrated in FIG. 10, node 5 now wants data represented by nodes 7, 9, and 10, then FIG. 11 illustrates the structure 1100 how this may be accomplished. A new soft link has been added that now connects node 5 to node 7.

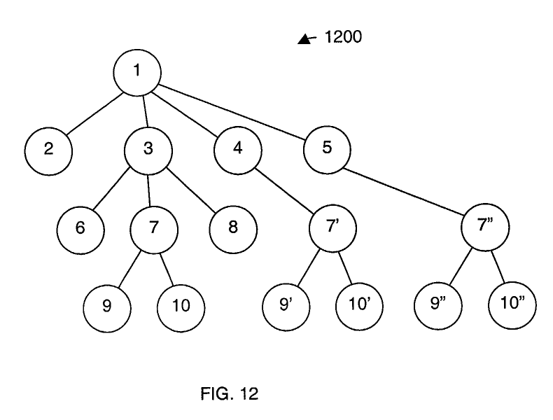

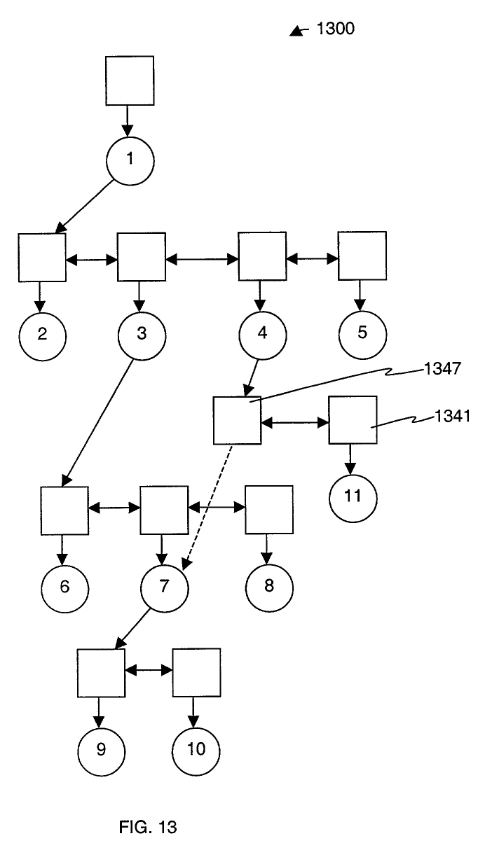

De-normalizing the structure 1100 in FIG. 11 and representing it as a tree would result in the structure 1200 as illustrated in FIG. 12 where prime (′) and double prime (″) indicators show data replicated from the respective nodes.

If, in FIG. 10, a new node 11 needed to be added and related to node 4, then in the format where the connectivity is separate from the node data, FIG. 13 would illustrate one such embodiment of the structure 1300 that may achieve this result. Here the connectivity information is in 1347 with a peer edge 1341. 1347 then connects to node 7 and 1341 connects to node 11. As may be seen, this approach maintains the linked list approach where an edge (□) only has one downlink to a node (◯), an edge (□) may have 0, 1, or 2 sibling links to other edges (□), and a node (◯) may have 0 or 1 links to another node (◯) or an edge (□).

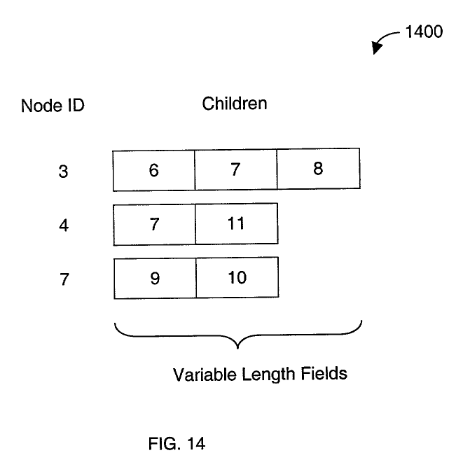

As has been shown in U.S. patent application No. Ser. No. 10/058,266 filed on Jan. 25, 2002, an XML representation may also be represented by, for example, arrays of objects. One skilled in the art will appreciate that a soft link may refer to an array of objects. For example, FIG. 14, illustrates one embodiment of an array of objects 1400 used to store, for example, Node ID information and the children of nodes 3, 4, and 7 as illustrated in FIG. 13. Here, the children nodes are stored in variable length fields. Node ID 3 has, for example, the children nodes of 6, 7 and 8. Referring back to FIG. 13 as an example of a soft link from node 4 to 7, and a link from 4 to 11, as represented in array objects in FIG. 14 it may be seen that node 4 refers to the array having children 7 and 11. Additionally, node 7 in FIG. 14 has children 9 and 10. Thus, a soft link may also be used with an array of objects to achieve XML normalization.

In yet another embodiment of the present invention, a logical data model using chunks may be used. As has been shown in U.S. patent application No. Ser. No. 10/058,266 filed on Jan. 25, 2002, XML may be represented by chunks. Chunks are groupings of objects. The chunks may be variable in size and thus a variable grained approach is possible. A chunk may be viewed as an array of member type objects. Thus, for example, referring to FIG. 13, the node 7 and children nodes 9 and 10 may be considered one chunk (denoted as Chunk #1). One skilled in the art will appreciate that a soft link my refer to a chunk. For example, in FIG. 13, a soft link, such as that from node 4 to 7 in FIG. 13, may be represented as a soft link from node 4 to Chunk #1. Thus, a soft link may also be used with chunks to achieve XML normalization.

One skilled in the art will appreciate that various combinations of the above are also possible as well as other approaches.

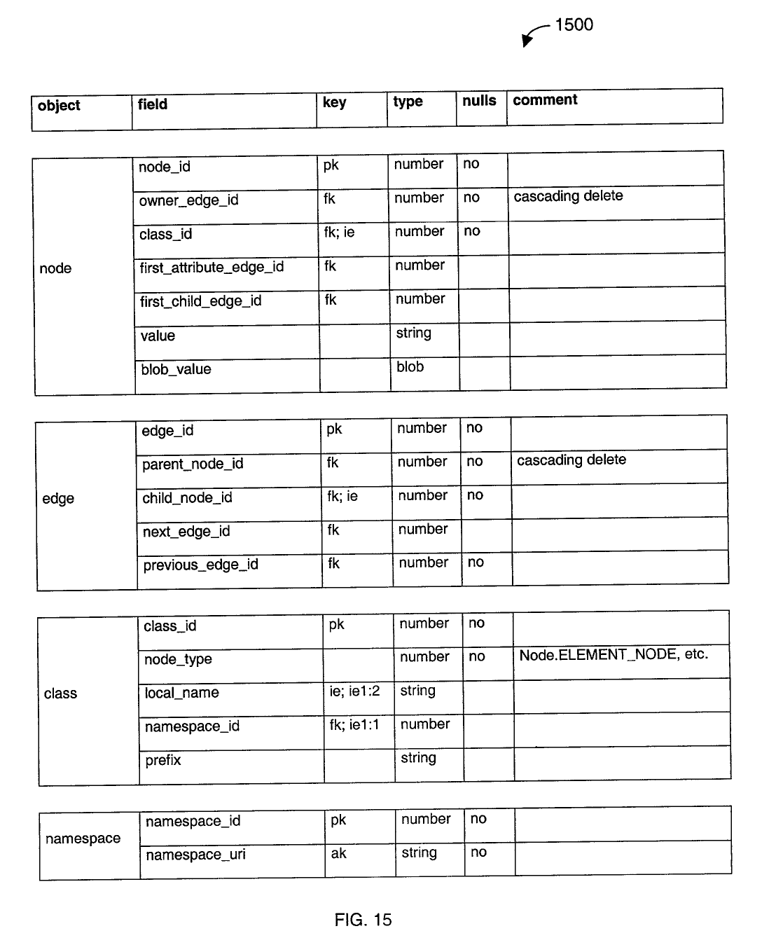

FIG. 15 illustrates one embodiment of a logical data model using linked lists as described above.

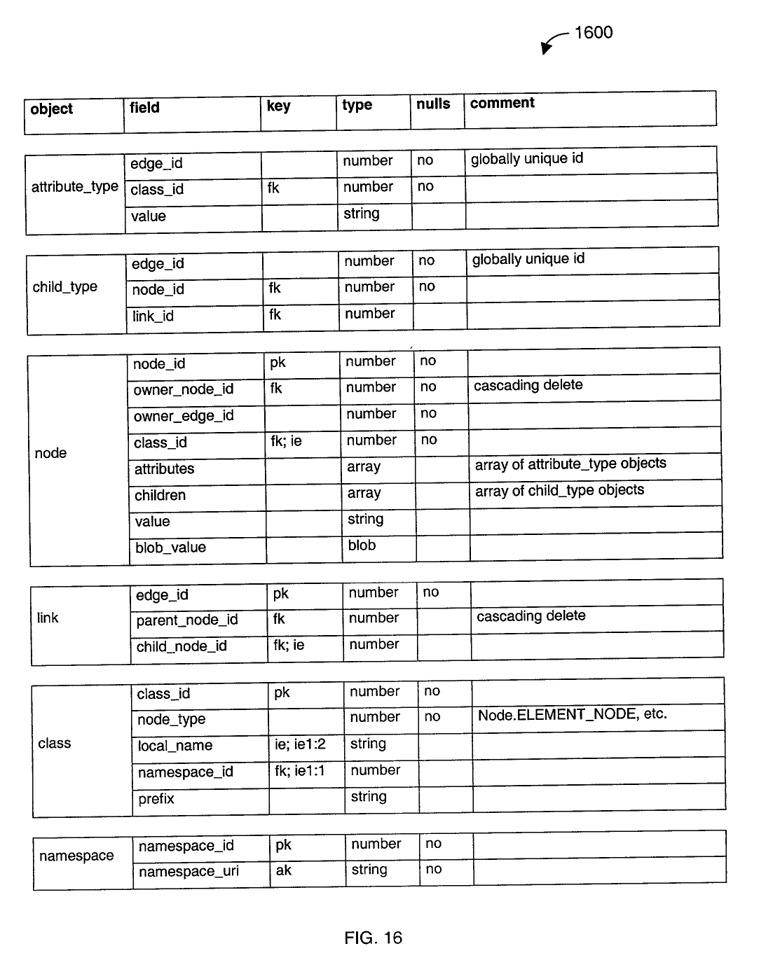

FIG. 16 illustrates another embodiment of a logical data model using arrays of objects.

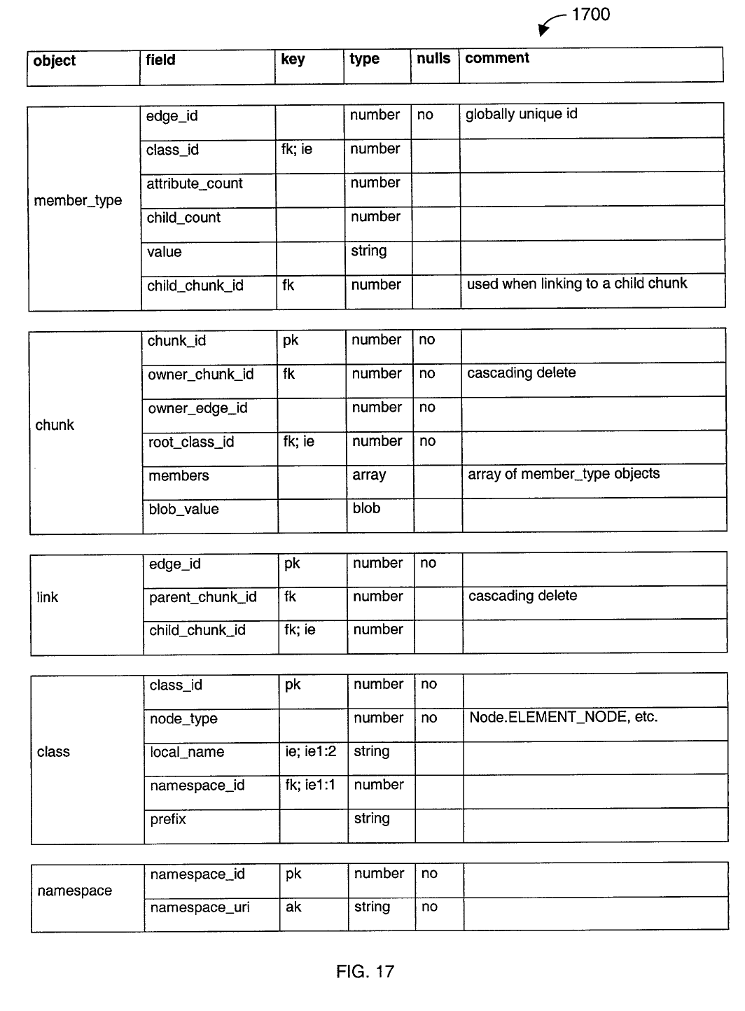

FIG. 17 illustrates another embodiment of a logical data model using chunks.

What will be noted in FIGS. 15, 16, and 17 is that the node and connectivity information (edge in FIG. 15, and link in FIGS. 16 and 17) is separated.

FIG. 15 illustrates an embodiment 1500 of a logical data model using linked lists to map to tables. This example is fine grained. The linked lists approach is a generic data model for trees and graphs. Its name comes from its use of linked lists of edges to capture sibling relationships among nodes. The linked lists model supports full structured search by exposing both the structure and data values, of for example XML data. As such, the XML query language XPath/XQuery may be used on this structure. This model supports grouping by allowing XML document nodes (the root nodes of XML documents) and/or XML element nodes to be children of other nodes. And it supports sharing by allowing any XML node to be reached from multiple parents (we call this XML normalization). Under key, pk denotes primary key, fk denotes foreign key, ie denotes inverted entry and notation such as pk1:1 denotes the first part of the composite primary key. As is illustrated, this example of a linked lists approach supports four objects: node, edge, class, and namespace. More information related to, for example, XML is supported in the model via such objects as class and namespace and the associated fields.

FIG. 16 illustrates an embodiment 1600 of a logical data model using arrays of objects. This example is fine grained. The array of objects model is capable of taking advantage of some non-relational features in database systems. Specifically, this model example takes advantage of support for array-valued columns. Array-valued columns may store variable-length arrays of structured types. In this embodiment, the model uses array-valued columns instead of linked lists to maintain the attribute list and child list of each node.

FIG. 17 illustrates an embodiment 1700 of a logical data model using chunks. This example is variable-grained because the chunks may be a varying size. That is, for example, this is a data model that allows XML data to be partitioned in variable-sized chunks. Whole chunks may be shared, retrieved, or updated, while a structured search may include conditions on individual nodes. The chunk model allows a tradeoff between performance and data granularity. However, because the chunks can be variable in size, in any implementation it may require either that the data be partitioned in advance, or there be logic to partition and re-partition the data as needed.

Thus, various embodiments illustrating XML normalization have been described.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Reference has been made to the extensible markup language (XML). It is to be understood that XML is an evolving language and as such that those aspects consistent with the present invention may evolve over time. Such concepts, as for example, well formed which is one of the basic underpinnings of XML is not likely to change. However, on the other hand, support for other data types, such as streaming media may well be defined in the future. As such, the present invention's display specification is to be understood as encompassing these extensions. The XML specification and related material may be found at the website of the World Wide Web Consortium (W3C) located at http://www.w3.org.

Reference has been made to “mapped into” and/or “mapped onto” or such like words. What is to be understood is that such terms as “into” or “onto” refer to an alternative way of representing one structure in terms on another structure and not that they are “in” or “on” such a structure. This alternative representation is performed by the “mapping.”

Reference has been made to database, data structure, relational database, etc. or such like words. What is to be understood is that such terms are often used to describe not only structure but also arrangement of data, relationships of data, and sometimes the actual data itself. One skilled in the art will understand from the context the proper meaning to be applied. For example, a relational database denotes that the data in the database is somehow related to some other data. This relationship might be, for example, implemented in tables, trees, graphs, etc. The common usage often views a relational database as a series of tables. The term data structure commonly refers to how the various pieces of information data (or more properly datum) are related to each other and the form that this representation takes, such as a tree form, rather than the actual format of the data, such as text, numbers, etc.

Likewise, data may be represented in alternative forms in different structures. For example, some structures may only support text or characters, in which case the representation of numbers may be by, for example, quoted strings. Another example is a database that supports dates, while another has no such support and so an alternative representation is needed.

Reference has been made to field, tree, graph, node, element, object, data, attribute, etc. Some of these terms as understood by one skilled in the art are often considered interchangeable and/or having the same essence in differing structures or schemes. For example, in a table database, such as a relational database, a unit of data may be in a field, this same unit of data in an XML environment may be in an entity called an attribute or a value. A node in XML may be called an object in an object oriented database. Nodes may be called a root if the node is at the top and children may be called sub-nodes. Nodes at the same level may be called siblings, etc. What is to be appreciated is that in the art, the words sometimes have meanings commensurate with the surrounding environment, and yet often the words are used interchangeably without respect to the specific structure or environment, i.e. one skilled in the art understands the use and meaning.

Thus, a method and apparatus for XML normalization in a relational database have been described.

What is claimed is:

1. A method comprising:
representing normalized extensible Markup Language (XML) information in a fixed set of tables.

2. The method of claim 1 wherein the fixed set of tables is in a relational database (RDB).

3. The method of claim 1 wherein the fixed set of tables is in a memory.

4. The method of claim 1 wherein the normalization further comprises soft links.

5. The method of claim 1 wherein the normalized XML information may be de-normalized to create a standard XML format.

6. The method of claim 1 wherein the normalized XML information is represented as a data structure selected from the group consisting of a directed graph, linked lists, an array of objects, and chunks.

7. The method of claim 6 wherein the normalized XML representation further comprises information selected from the group consisting of node information, edge information, link information, class information, namespace information, and attribute information.

8. The method of claim 1 wherein the normalized XML representation comprises information selected from the group consisting of node information, parent information, child information, sibling information, edge information, link information, class information, namespace information, member information, chunk information, and attribute information.

9. The method of claim 8 wherein the sibling information is selected from the group consisting of next sibling identification (ID) and previous sibling ID.

10. The method of claim 8 wherein the representation further comprises:
a child array identification (ID); and
a child array.

11. The method of claim 8 wherein the representation further comprises:
a chunk identification (ID); and
a chunk.

12. The method of claim 1 wherein the fixed set of tables further comprises a plurality of fixed different sized tables.

13. The method of 1 wherein the tables represent structure information selected from the group consisting of at least one node and at least one subnode.

14. A processing system comprising a processor, which when executing a set of instructions performs the method of claim 1.

15. A machine-readable medium having stored thereon instructions, which when executed performs the method of claim 1.

16. A method comprising:
converting a standard XML tree structure into a representation having reduced redundancy.

17. The method according to claim 16, wherein the reduced redundancy representation (RRR) may be represented as a fixed set of tables.

18. The method of claim 17 wherein the RRR has nodes and subnodes, and the method may be applied recursively to any node and its sub-nodes.

19. The method of claim 17 wherein the fixed set of tables is selected from the group consisting of a linked list, an array of objects, and variable-grained chunks.

20. The method of claim 17 wherein the fixed set of tables further comprises a plurality of fixed different sized tables.

21. The method of claim 16 further comprising the representation being stored in a relational database.

22. The method of claim 16 further comprising the representation being stored in a memory.

23. A processing system comprising a processor, which when executing a set of instructions performs the method of claim 16.

24. A machine-readable medium having stored thereon instructions, which when executed performs the method of claim 16.

25. An apparatus comprising:
means for creating a graph based data structure representing a standard XML tree structure; and
means for transforming the graph based data structure to a fixed set of tables.

26. The apparatus of claim 25 further comprising means for transforming data represented in the graph based data structure.

27. The apparatus of claim 25 wherein the fixed set of tables is substantially a relational database.

28. The apparatus of claim 25 wherein the fixed set of tables is substantially a memory data structure.

29. The apparatus of claim 25 wherein the graph based data structure is substantially represented by an XML document.

30. A machine-readable medium having stored thereon information representing the apparatus of claim 25.

31. A system comprising a processor, which when executing a set of instructions, performs the following:
inputs an XML tree data structure
creates a graph based data structure representation of the XML tree data structure;
transforms the graph based data structure to tables; and
outputs the tables.

32. The system of claim 31 wherein the transformation is to a fixed set of tables.

33. The system of claim 31 wherein the transformation is to a fixed set of different sized tables.

34. The system of claim 31 wherein the transformation to tables is based substantially upon an XML representation.

35. The system of claim 31 further comprising transferring a payment and/or a credit.

36. A method for representing a normalized extensible Markup Language (XML) data structure as a fixed set of tables in a relational database (RDB), the method comprising:
(a) inputting the normalized XML data structure;
(b) grouping at least one XML node and possibly any sub-node into a relationship selected from the group consisting of linked list, array of object, and chunk;
(c) generating a fixed sized table for the grouping in (b);
(d) if necessary, repeating (b) and (c) and creating references to any repeated groupings (b) and tables (c), until the normalized XML data structure is completed; and
(e) outputting the resulting fixed sized tables for use in the RDB.

37. A method for extracting a normalized XML data structure represented as a fixed set of tables in a relational database (RDB), the method comprising:
(a) inputting the fixed sized tables from the RDB;
(b) ungrouping from a table a relationship selected from the group consisting of linked list, array of object, and chunk;
(c) generating at least one XML node and possibly any sub-node for the ungrouping in (b);
(d) if necessary, repeating (b) and (c) and creating references to any repeated ungroupings (b) and nodes and possibly any sub-nodes (c), until the normalized XML data structure is completed; and
(e) outputting the resulting normalized XML data structure.

38. A method for representing a normalized extensible Markup Language (XML) data structure as a fixed set of tables in a memory data structure, the method comprising:
(a) inputting the normalized XML data structure;
(b) grouping at least one XML node and possibly any sub-node into a relationship selected from the group consisting of linked list, array of object, and chunk;
(c) generating a fixed sized table for the grouping in (b);
(d) if necessary, repeating (b) and (c) and creating references to any repeated groupings (b) and tables (c), until the normalized XML data structure is completed; and
(e) outputting the resulting fixed sized tables for use in the memory data structure.

39. A method for extracting a normalized XML data structure represented as a fixed set of tables in a memory data structure, the method comprising:
(a) inputting the fixed sized tables from the memory data structure;
(b) ungrouping from a table a relationship selected from the group consisting of linked list, array of object, and chunk;
(c) generating at least one XML node and possibly any sub-node for the ungrouping in (b);
(d) if necessary, repeating (b) and (c) and creating references to any repeated ungroupings (b) and nodes and possibly any sub-nodes (c), until the normalized XML data structure is completed; and
(e) outputting the resulting normalized XML data structure.
